(19) United States
(12) Patent Application Publication
(10) Pub. No.: US 2025/0232161 A1
(43) Pub. Date: Jul. 17, 2025

(54) METHOD AND DEVICE WITH NEURAL NETWORK MODEL QUANTIZATION

(71) Applicant: Samsung Electronics Co., Ltd., Suwon-si (KR)

(72) Inventors: Gang SUN, Xi'an (CN); Guoqiang HE, Xi'an (CN); Jun-Woo JANG, Suwon-si (KR); Penghui WEI, Xi'an (CN)

(73) Assignee: Samsung Electronics Co., Ltd., Suwon-si (KR)

(21) Appl. No.: 19/021,626

(22) Filed: Jan. 15, 2025

(30) Foreign Application Priority Data
Jan. 15, 2024 (CN) 202410056812.1
Oct. 15, 2024 (KR) 10-2024-0140380

(51) Int. Cl. G06N 3/0495

(52) U.S. Cl. CPC G06N 3/0495

(57) ABSTRACT

A quantization method for a neural network model is provided. The quantization method includes: determining sensitivities corresponding to one candidate max weight error (MWE) among candidate MWEs corresponding to the target layer, the sensitivities sensitivity of the neural network model to quantization; determining a target MWE corresponding to the target layer, based on the sensitivities; and based on the determined target MWE, quantizing weights included in the target layer from a first data format to a second data format.

### CROSS-REFERENCE TO RELATED APPLICATIONS

This application claims the benefit under 35 USC § 119 (a) of Chinese Patent Application No. 202410056812.1, filed on Jan. 15, 2024, in the China National Intellectual Property Administration, and Korean Patent Application No. 10-2024-0140380, filed on Oct. 15, 2024, in the Korean Intellectual Property Office, the entire disclosures of which are incorporated herein by reference for all purposes.

### BACKGROUND

### 1. Field

The following description relates to quantization of a neural network model, and more particularly, to a method, an electronic device, and a storage medium for quantizing a neural network model.

### 2. Description of Related Art

In the field of artificial intelligence (AI) computing, data processed by AI chips can have high precision. At the same time, the data processed by AI chips can bring enormous memory access and computational delay overhead to the AI chips. However, due to limitations in power consumption, area, and computing resources of AI chips, the inference operations of AI chips in real-world scenarios may be preferably performed using data with low precision. Therefore, by using data with low precision, AI chips can reduce the amount of data moving during the inference process, reduce power consumption due to memory access of the AI chip, and reduce power consumption and area overhead of the multiply-accumulation (MAC) computing unit of the AI chip.

However, neural network models can perform inference operations based on higher precision data to achieve better inference accuracy. Therefore, applying neural network models that perform inference operations with high-precision data to AI chips that are better suited to using low-precision data has recently become an area of interest.

Quantization of neural network models is one way to solve the above problem. However, existing quantization methods often have difficulty simultaneously satisfying the requirement of maintaining the inference accuracy of the quantized neural network model while minimizing the overhead of the AI chip (e.g., the amount of computations or power consumption during inference).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a quantization method for quantizing a target layer among layers of a neural network model is performed by one or more processors and includes: determining sensitivities corresponding to one candidate max weight error (MWE) among candidate MWEs corresponding to the target layer, the sensitivities indicating sensitivity of the neural network model to quantization; determining a target MWE corresponding to the target layer, based on the sensitivities; and based on the determined target MWE, quantizing weights included in the target layer from a first data format to a second data format.

The determining of the plurality of sensitivities may include determining a first sensitivity of the target layer to a first performance indicator, the first sensitivity corresponding to the determined target MWE, determining a second sensitivity of the target layer to a second performance indicator, the second sensitivity corresponding to the determined target MWE, and determining a target sensitivity of the target layer, the target sensitivity corresponding to the determined target MWE, based on combining the first sensitivity and the second sensitivity.

In response to operating, based on a predetermined artificial intelligence (AI) chip, a quantized model obtained by quantizing the weights included in the target layer from the first data format to the second data format, the first performance indicator and the second performance indicator may each correspond to one of power consumption of the AI chip, an area of the AI chip, a computational complexity ratio (CCR), and a computational accuracy of the quantized model, and the first performance indicator may be different from the second performance indicator.

The determining of the plurality of sensitivities may include generating first output data, based on inputting first input data to the neural network model, generating a quantized model by quantizing the weights included in the target layer from the first data format to the second data format, based on the determined target MWE, generating second output data, based on inputting the first input data to the quantized model, and determining a target sensitivity of the target layer, the target sensitivity corresponding to the determined target MWE, based on the first output data and the second output data.

The determining of the target MWE corresponding to the target layer may include determining the target MWE, based on a comparison result of a plurality of sensitivities corresponding to the one candidate MWE and a plurality of sensitivities corresponding to other candidate MWEs than the one candidate MWE.

The second data format may include a first sub-format and a second sub-format, a precision of the first sub-format or the second sub-format is lower than a precision of the first data format, and the quantizing of the weights included in the target layer from the first data format to the second data format, based on the target MWE, may include: quantizing weights of the target layer determined to fall within a first range into the first sub-format; and quantizing weights of the target layer determined to fall within a second range into the second sub-format.

The first data format may correspond to a half-precision data format, the second data format may include a first dynamic floating-point data format and a second dynamic floating-point data format, which have a predetermined precision size, and the quantizing of the weights included in the target layer from the first data format to the second data format, based on the target MWE, may include determining a first threshold value and a second threshold value less than the first threshold value for dividing the weights included in the target layer into a plurality of ranges, based on the target MWE, quantizing, into the first sub-data format, the weights included in (determined to fall within) the first range corresponding to a range between the first threshold value and a number having a same size as the first threshold value and an opposite sign from the first threshold value, quantizing, into the first DFP data format, weights included in (determined to fall within) a first sub-range corresponding to a range between a number having a same size as the second threshold value and an opposite sign from the second threshold value and the number having the same size as the first threshold value and the opposite sign from the first threshold value, and a range between the first threshold value and the second threshold value, among the second range, and quantizing, into the second DFP data format, weights included in (determined to fall withing) a second sub-range corresponding to a range greater than the number having the same size as the second threshold value and the opposite sign from the second threshold value and a range less than the second threshold value, among the second range.

The quantization method may further include performing inference based on inputting multimedia data to a quantized model generated through the quantization method for the neural network model, wherein the multimedia data may include at least one of text data, image data, or voice data.

The quantization method may further include dividing the plurality of layers into a plurality of groups, based on a weight distribution of weights included in each of the plurality of layers, and quantizing weights of layers other than the target layer, which may be included in a first group, among the plurality of groups, including the target layer, from the first data format to the second data format, based on the target MWE corresponding to the target layer.

The dividing of the plurality of layers into the plurality of groups may include calculating a similarity between a first weight distribution of weights included in a first layer and a second weight distribution of weights included in a second layer, among the plurality of layers, and dividing the plurality of layers into the plurality of groups, based on the calculated similarity.

In another general aspect, a quantization device for a neural network model includes a processor including a sensitivity determination module, in the neural network model including a plurality of layers, configured to determine a plurality of sensitivities corresponding to one candidate max weight error (MWE) among a plurality of predetermined candidate MWEs corresponding to a target layer, an MWE determination module configured to determine a target MWE corresponding to the target layer, based on the plurality of sensitivities, and a quantization module configured to quantize weights included in the target layer from a first data format to a second data format, based on the target MWE, and a memory configured to store instructions for operating the processor.

The sensitivity determination module may be configured to determine a first sensitivity of the target layer to a first performance indicator, the first sensitivity corresponding to the determined target MWE, determine a second sensitivity of the target layer to a second performance indicator, the second sensitivity corresponding to the determined target MWE, and determine a target sensitivity of the target layer, the target sensitivity corresponding to the determined target MWE, based on combining the first sensitivity and the second sensitivity.

In response to operating, based on a predetermined artificial intelligence (AI) chip, a quantized model obtained by quantizing the weights included in the target layer from the first data format to the second data format, the first performance indicator and the second performance indicator may each correspond to one of power consumption of the AI chip, an area of the AI chip, a computational complexity ratio (CCR), and a computational accuracy of the quantized model, and the first performance indicator may be different from the second performance indicator.

The sensitivity determination module may be configured to generate first output data, based on inputting first input data to the neural network model, generate a quantized model by quantizing the weights included in the target layer from the first data format to the second data format, based on the determined target MWE, generate second output data, based on inputting the first input data to the quantized model, and determine a target sensitivity of the target layer, the target sensitivity corresponding to the determined target MWE, based on the first output data and the second output data.

The MWE determination module may be configured to determine the target MWE, based on a comparison result of a plurality of sensitivities corresponding to the one candidate MWE and a plurality of sensitivities corresponding to other candidate MWEs than the one candidate MWE.

The second data format may include a first sub-data format and a second sub-data format, a precision of at least one of the first sub-data format and the second sub-data format may be lower than a precision of the first data format, and the quantization module may be configured to divide the weights included in the target layer into a first range and a second range, based on the target MWE, the second range being different from the first range, quantize weights included in the first range into the first sub-data format, and quantize weights included in the second range into the second sub-data format.

The first data format may include a half-precision data format, the second data format may include a first dynamic floating-point data format and a second dynamic floating-point data format, which have a predetermined precision size, and the quantization module may be configured to determine a first threshold value and a second threshold value less than the first threshold value for dividing the weights included in the target layer into a plurality of ranges, based on the target MWE, quantize, into the first sub-data format, the weights included in the first range corresponding to a range between the first threshold value and a number having a same size as the first threshold value and an opposite sign from the first threshold value, quantize, into the first DFP data format, weights included in a first sub-range corresponding to a range between a number having a same size as the second threshold value and an opposite sign from the second threshold value and the number having the same size as the first threshold value and the opposite sign from the first threshold value, and a range between the first threshold value and the second threshold value, among the second range, and quantize, into the second DFP data format, weights included in a second sub-range corresponding to a range greater than the number having the same size as the second threshold value and the opposite sign from the second threshold value and a range less than the second threshold value, among the second range.

The processor may be configured to divide the plurality of layers into a plurality of groups, based on a weight distribution of weights included in each of the plurality of layers, and quantize weights of layers other than the target layer, in a first group, among the plurality of groups, comprising the target layer, from the first data format to the second data format, based on the target MWE corresponding to the target layer.

The processor may be configured to calculate a similarity between a first weight distribution of weights included in a first layer among the plurality of layers and a second weight distribution of weights included in a second layer, and divide the plurality of layers into the plurality of groups, based on the calculated similarity.

Other features and aspects will be apparent from the following detailed description, the drawings, and the claims.

### BRIEF DESCRIPTION OF THE DRAWINGS

FIG. 1 illustrates an example of a neural network model quantization method performed by a neural network model quantization device, according to one or more embodiments.

FIG. 2 illustrates an example of a method by which an electronic device may determine a sensitivity of a target layer included in a neural network model, according to one or more embodiments.

FIG. 3 illustrates an example of a method by which an electronic device may determine sensitivities corresponding to a target layer of a neural network model, according to one or more embodiments.

FIG. 4 illustrates an example of a method by which an electronic device may quantize a weight of a target layer from a first data format to a second data format, according to one or more embodiments.

FIG. 5 illustrates an example of a dynamic floating-point conversion (DFC) algorithm, according to one or more embodiments.

FIG. 6 illustrates an example of a neural network model quantization method performed by an electronic device, according to one or more embodiments.

FIG. 7 illustrates an example of a device that quantizes a neural network model, according to one or more embodiments.

FIGS. 8A and 8B illustrate an example of an architecture of an electronic device that operates a neural network model, according to one or more embodiments.

FIG. 9 illustrates an example of an overall flow of a neural network model quantization algorithm, according to one or more embodiments.

FIG. 10 illustrates an example of an overall flow in which a group division module divides a neural network model into groups, based on a cross-layer grouping algorithm, according to one or more embodiments.

FIG. 11 illustrates an example of an overall flow of a multi-objective optimization algorithm, according to one or more embodiments.

FIG. 12 illustrates an example of an overall flow of a DFC algorithm, according to one or more embodiments.

FIG. 13 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

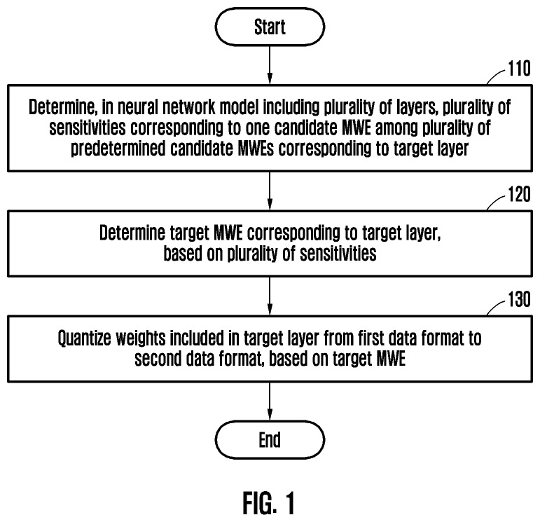

FIG. 1 illustrates an example of a neural network model quantization method performed by a neural network model quantization device, according to one or more embodiments.

In FIG. 1, a neural network model quantization device (hereinafter, an electronic device) may quantize a neural network model based on a type, specifications (e.g., a memory size), and/or performance of hardware that will be operating the neural network model (i.e., “target hardware”). For example, the electronic device may recognize a data format that is supported by the target hardware. The neural network model may be configured, before quantization thereof, to have an operation thereof be performed in a predetermined specific data format, for example, in a floating-point 16 (FP16) format. In some cases, the target hardware may support the same data format as the data format of the neural network model (e.g., both may be configured for a FP16 operation). However, in other cases, the target hardware may support a data format (e.g., INT8) having lower precision than the data format (e.g., FP16) of the neural network model, which may provide improved computational speed of implementing (e.g., performing an inference with) the neural network model. Accordingly, the electronic device may quantize the neural network model, i.e., may change the data format of the neural network model, and may do so based on comparing the data format of the neural network model with the data format supported by the target hardware that will be operating the neural network model. When the data formats differ, the electronic device may quantize the neural network model so that an operation of the neural network model can be performed on the recognized data format of the target hardware. For example, the target hardware may include an artificial intelligence (AI) chip. For example, the target hardware may include a central processing unit (CPU), a graphics processing unit (GPU), a tensor processing unit (TPU), and/or a neural processing unit (NPU). As described above, the target hardware may generally be capable of operating/implementing the neural network model in a data format with lower precision than the unquantized/original data format (e.g., FP16) of the neural network model due to, for example, limitations/goals of power consumption, occupied chip area, computing resource usage, or the like (which may correspond to performance indicators, described below). Thus, the electronic device may decide to quantize the data of the neural network model from the data format of the neural network model (pre quantization) down to the data format supported by the target hardware. Although the electronic device and the target hardware are described above as separate components, in some implementations the electronic device may also operate/implement the neural network model (i.e., the electronic device may be the target device). Methods by which the electronic device may quantize the neural network model are described herein.

The neural network model of FIG. 1 may be a previously-trained neural network model that is to be quantized. An original precision of data of the neural network model may be relatively high compared to a precision of data that may be processed by the target hardware. For example, the precision of data of the neural network model (e.g., weights thereof) may include FP16, and the data processing precision of the target hardware may include FP8, as non-limiting examples. The electronic device may obtain the neural network model from a database. For example, the electronic device may obtain the neural network model from a database on a cloud server and/or from a database on a mobile device with a limited memory. However, the method by which the electronic device obtains the neural network model is not limited thereto, and the electronic device may obtain the neural network model from another external hardware device (e.g., a secure digital (SD) card or a small external hard drive) or may train the model itself.

The electronic device may receive multimedia data and perform an inference operation by applying the neural network model to the received multimedia data. For example, the multimedia data may be text data, image data, or voice data. For example, the neural network model may include a neural network model (e.g., a deep learning neural network model) trained to perform image recognition, natural language processing, and/or recommendation system processing.

In operation 110, the electronic device may determine candidate max-weight-errors (MWEs) corresponding to a target layer among layers of the neural network model. An MWE may be an upper bound of a weight error introduced by quantizing weights of the neural network model (e.g., an error corresponding to a performance/sensitivity difference between the neural network model before quantization and the neural network model after quantization). An example formula for computing MWE is described below with reference to Equation 1. The MWE may also be referred to as an allowable weight-error, a reference weight-error, or a weight-error limit, and terms referring to the MWE are not limited thereto. For example, the electronic device may determine the candidate MWEs according to computational performance of the target hardware with respect to performing an operation of the neural network model. For example, an operation of the neural network model may be performed based on the FP16 data format, whereas the target hardware may perform the operation based on the FP8 data format. In other words, the electronic device may determine the candidate MWEs (which correspond to the target layer of the neural network model) depending on the data format (e.g., FP8) supported by the hardware. In another example, the candidate MWEs may be determined based on a user input, and may be determined in advance. For reference, an example method for computing the MWE is expressed by Equation 1 below.

$$Mean ( Abs ( {tensor}_{1} - {tensor}_{2} ) ) \leq MWE \qquad Equation 1$$

In Equation 1, Mean( ) denotes a function used to calculate an average, and Abs ( ) denotes a function used to calculate an absolute value. tensor₁ denotes a tensor corresponding to the target layer before quantizing the neural network model. tensor₂ denotes a corresponding tensor of the target layer after quantizing the neural network model. For reference, the neural network model may include multiple target layers. For example, the neural network model may include a first target layer and a second target layer. In Equation 1, tensor 1 may include a tensor value before quantization of the first target layer and a tensor value before quantization of the second target layer. In addition, tensor 2 may include a tensor value after quantization of the first target layer and a tensor value after quantization of the second target layer. Therefore, Equation 1 may represent an average based on the absolute value of the error of the tensor values before and after quantization for the first target layer and the absolute value of the error of the tensor values before and after quantization for the second target layer. In other words, the MWE may be the maximum possible/allowed value of the average of absolute differences between a tensor of the target layer before quantization and a tensor corresponding to the target layer after quantization. As a non-limiting example, the tensors corresponding to the target layer may (e.g., tensor₁ and tensor₂) be an input tensor of the target layer, a output tensor of the target layer, and/or a weight tensor included in the target layer. That is, tensor₁ and tensor₂ may both be an input tensor, may both be an output tensor, and/or may both be a weight tensor (both are a same tensor aspect of the target layer, albeit having different values). The electronic device may determine sensitivities corresponding to the target layer. For example, the electronic device may perform a same operation of the neural network model (e.g., an inference on a same input) different times based on the different candidate quantization data formats, respectively, and each sensitivity of the target layer may represent a sensitivity of the target layer to a predetermined criterion with respect to a corresponding candidate quantization data format. For example, when the data format of the neural network model before quantization (e.g., a data format of a weight) is a first data format and the data format of the neural network model after quantization is a second data format, a corresponding sensitivity may represent a degree to which the second data format affects the predetermined criterion compared to the first data format, i.e., the performance indicator determined using the target layer in the first data format as compared to the performance indicator determined using the target layer in the second data format. As non-limiting examples, the performance indicator may be an accuracy of the neural network model, a computational complexity rate (CCR) of the neural network model, power consumption of a chip for implementing the neural network model, and/or an area of the chip. In other words, the sensitivity may include, but is not limited to, a value representing a degree to which the performance indicator (e.g., the accuracy, the CCR, the power consumption of the chip, and the area of the chip) is affected when the electronic device quantizes the target layer of the neural network model. Or, put another way, the sensitivity may indicate how sensitive the target layer is, as measured by the performance indicator, to the second data format (here, the second data format abstractly representing any of the candidate quantization data formats).

For example, the first data format may be a half-precision data format (e.g., FP16). In addition, the second data format may be a dynamic floating-point (DFP) data format, a 16-bit brain floating point 16 (BF16) data format, a TensorFloat-32 (TF32) data format, or an 8-bit floating-point (FP8) data format.

In other words, the electronic device may determine the candidate MWEs (corresponding to the target layer of the neural network model, possibly in advance) and may determine sets of sensitivities respectively corresponding to the candidate MWEs. For example, the electronic device may determine a first candidate MWE, a second candidate MWE, and so forth up to an n-th candidate MWE, all of which correspond to the target layer. The electronic device may determine a first set of sensitivities corresponding to the first candidate MWE, a second set of sensitivities corresponding to the second candidate MWE, and so forth up to an n-th set of sensitivities corresponding to the n-th candidate MWE.

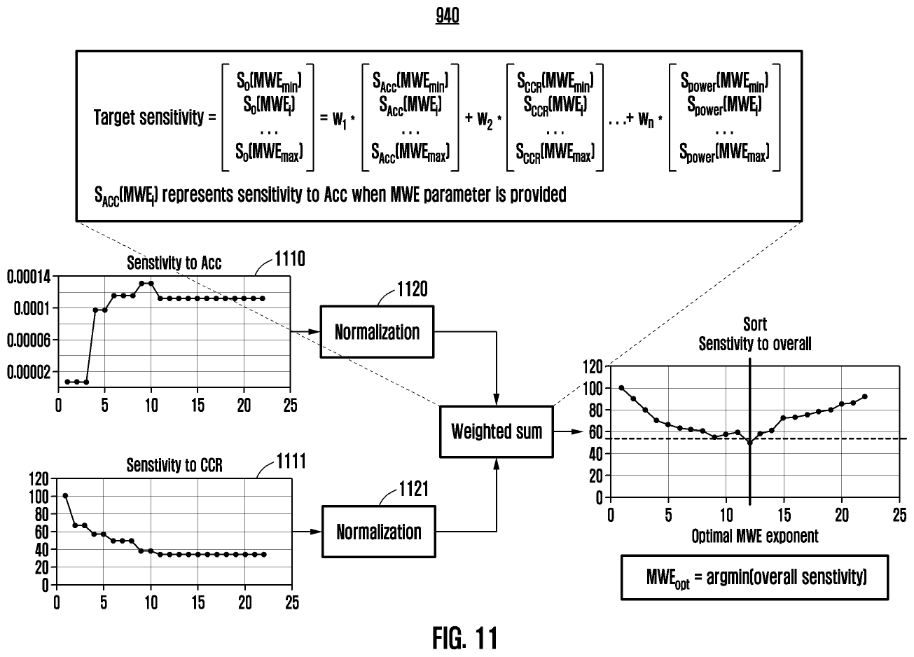

In operation 120, the electronic device may determine/select a target MWE corresponding to the target layer, based on the sensitivities. For example, the electronic device may determine a candidate MWE having a minimum sensitivity, among the sensitivities corresponding to each of the candidate MWEs, to be the target MWE corresponding to the target layer. In other words, the electronic device may determine/select the target MWE corresponding to the target layer to be the MWE having a best performance indicator value for the target layer among the plurality of MWEs. The specific method by which the electronic device determines the target MWE is described in detail below with reference to FIG. 11.

In operation 130, the electronic device may quantize weights included in the target layer from a first data format to a second data format, based on the target MWE corresponding to the target layer.

Regarding the weights, weights of the first data format may be weights in the target layer before quantization, and weights of the second data format may be weights in the target layer of the neural network model after quantization.

Furthermore, the second data format may include a first sub-format and a second sub-format (“sub-format” being short for “data sub-format”). In this case, a precision of the first sub-format and/or a precision of the second sub-format may be lower than a precision of the first data format.

Regarding use of the target MWE for quantizing the target layer, the target MWE may be used to determine a first weight-range within which weights of the target layer are to be quantized to the first sub-format and a second weight-range within which weights of the target layer are to be quantized to the second sub-format. In another example, the second data format may include three or more sub-formats, e.g., a first sub-format, a second sub-format, and a third sub-format. Precision of the first to third sub-formats may differ from each other.

The electronic device may quantize weights of the target layer from the first data format to the second data format, and may do so using whichever of the candidate MWEs (the target MWE) brings about the best performance of the target layer. Thus, the electronic device may obtain a good performance indicator when storing a quantized neural network in an AI chip/accelerator that may perform an operation corresponding to the quantized neural network or when executing a quantized neural network through the AI chip.

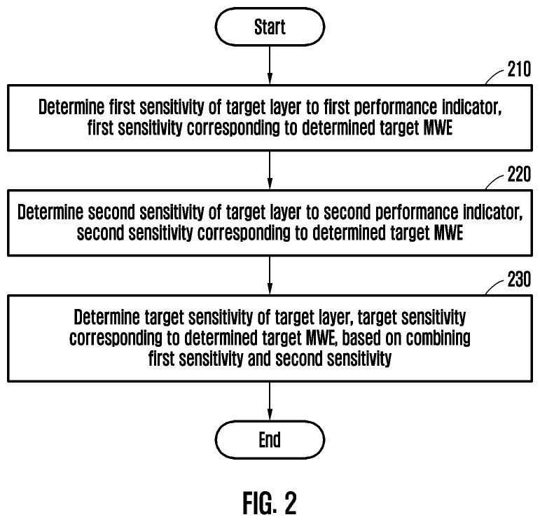

FIG. 2 illustrates an example of a method by which an electronic device may determine a sensitivity of a target layer included in a neural network model, according to one or more embodiments.

In operation 210, the electronic device may determine a first sensitivity of at least one layer (e.g., a target layer) to a first performance indicator, the first sensitivity corresponding to a selected MWE. Here, the selected MWE may be one MWE selected from among MWEs. In other words, the electronic device may determine, for the determined target MWE, the first sensitivity of the target layer to the first performance indicator. For example, when the data format of the neural network model before quantization is a first data format and the data format of the neural network model after quantization is a second data format, the first sensitivity (to the first performance indicator) of the target layer may represent an influence of the second data format on the first performance indicator compared to (or relative to) the first data format (i.e., the first performance indicator per the first data format compared to the first performance indicator per the second data format). For example, the first performance indicator may correspond to power consumption of a chip, an area of the chip, a CCR, or a computational accuracy of the target layer after quantization.

In operation 220, the electronic device may determine a second sensitivity of the at least one layer (e.g., target layer) to a second performance indicator (other than the first performance indicator), the second sensitivity corresponding to a selected MWE. For example, when the data format of the neural network model before quantization is the first data format and the data format of the neural network model after quantization is the second data format, the second sensitivity (to the second performance indicator) of the target layer may represent an influence of the second data format on the second performance indicator compared to (relative to) the first data format (i.e., the second performance indicator per the first data format compared to the second performance indicator per the second data format). For example, the first and second performance indicators may be any of the target layer's performance indicators such as accuracy, the CCR, the power consumption of the chip, or the area of the chip, but they are not the same performance indicator.

In operation 230, the electronic device may determine a target sensitivity of the target layer corresponding to the selected MWE by combining the first sensitivity and the second sensitivity. For example, the electronic device may combine the first sensitivity and the second sensitivity, by performing a weighted sum of the first sensitivity and the second sensitivity. The electronic device may assign weight coefficients to the respective sensitivities to perform the weighted sum of the first sensitivity and the second sensitivity. For example, the weight coefficients may be predetermined by a user. For example, the user or the electronic device may set a greater weight for a sensitivity corresponding to the user's preferred performance indicator. Thus, the electronic device may better meet comprehensive needs of the user for various performance indicators by comprehensively considering the sensitivity of an operation performed in the target layer of the neural network model to various performance indicators. Combining the first sensitivity and the second sensitivity through the weighted sum method is a non-limiting example. In addition, the electronic device may also determine the target sensitivity by combining sensitivities of the target layer to additional respective performance indicators (i.e., the target sensitivity may be based on a combination of three or more sensitivities). For reference, the target sensitivity may also be referred to as a composite sensitivity that combines all performance-indicator-specific sensitivities, of the target layer. However, examples are not limited thereto.

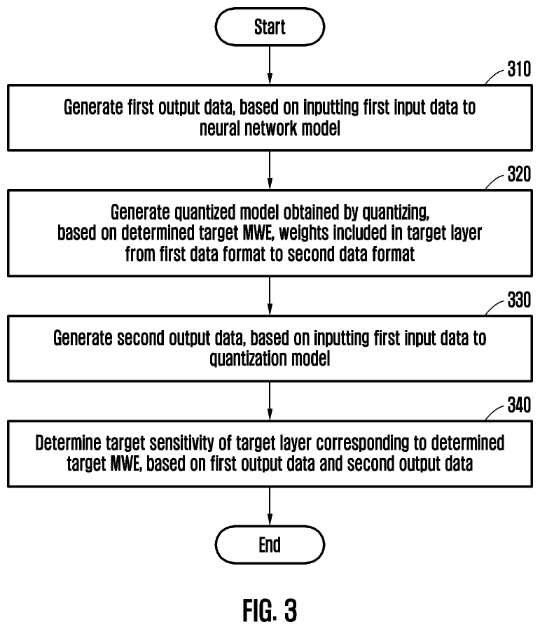

FIG. 3 illustrates an example of a method by which an electronic device may determine sensitivities corresponding to a target layer of a neural network model, according to one or more embodiments.

In operation 310, the electronic device may generate first output data, based on inputting first input data to the neural network model. For example, the first input data may include multimedia data as described above with reference to FIG. 1 (e.g., text data, image data, or voice data). The first output data may be a result of inference performed by the electronic device on the first input data, based on the neural network model including a target layer having a first data format. Here, the result of the inference may include, for example, an image recognition result, a natural language processing result, or a voice recognition result, as non-limiting examples.

In operation 320, the electronic device may generate a quantized model obtained by quantizing, based on a determined target MWE, the weights included in the target layer from the first data format to a second data format. For example, in a process of quantizing a weight of the first data format of the target layer to a weight of the second data format, the electronic device may control (or adjust) an error between (i) a weight before conversion/quantization and (ii) a weight after conversion/quantization to be less than or equal to the determined target MWE.

In operation 330, the electronic device may generate (infer) second output data, based on inputting the first input data to the quantized model. The second output data generated from the quantized model may be a result of inference performed by the electronic device on the first input data based on the quantized model (which includes the target layer having the second data format).

In operation 340, the electronic device may determine a target sensitivity of the target layer corresponding to the determined target MWE, based on the first output data and the second output data. For example, the electronic device may calculate the sensitivity of the target layer, based on a difference (e.g., a relative error and/or an absolute error) between the first output data and the second output data. For example, the electronic device may calculate the target sensitivity such that the target sensitivity of the target layer is high when a difference between the first output data and the second output data is large (e.g., target sensitivity is proportional to the difference). In another example, the electronic device may calculate the target sensitivity of the target layer such that it is low when the difference between the first output data and the second output data is small (e.g., target sensitivity is inversely proportional to the difference).

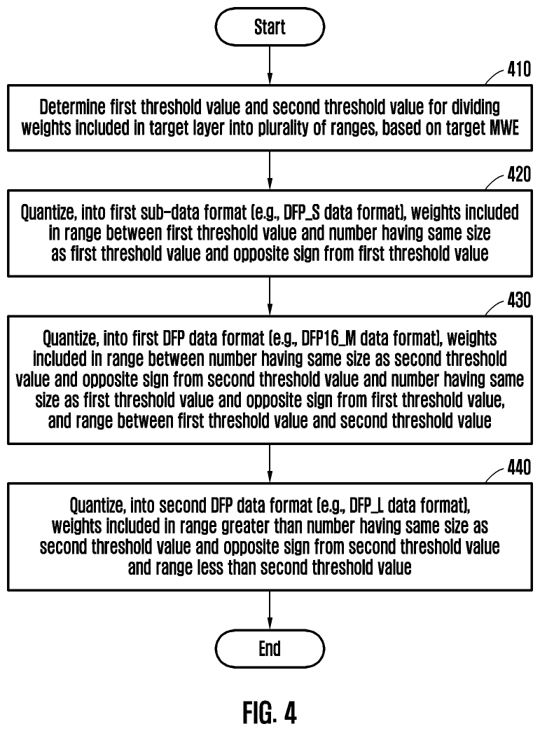

FIG. 4 illustrates an example of a method by which an electronic device may quantize a weight of a target layer from a first data format to a second data format, according to one or more embodiments. Before describing the operations of FIG. 4, various data formats are described.

As described above with reference to FIG. 1, the first data format may include a half-precision data format (e.g., the FP16 data format). In addition, the second data format may include a first sub-format and a second sub-format. For example, the second data format may include a DFP data format. For example, the DFP data format may include a first sub-format, a first DFP data format, and a second DFP data format. For example, the first sub-format may include a DFP_S (small) data format. For example, the first DFP data format may include a DFP_M (medium) data format. For example, the second DFP data format may include a DFP_L (large) data format.

Among first sub-formats, the DFP_S data format may correspond to DFP_S(1-5-4); a data format that includes one sign bit, five exponent bits, and four mantissa (significand) bits.

Among first DFP data formats, the DFP_M data format may correspond to DFP_M(1-5-8); a data format that includes one sign bit, five exponent bits, and eight mantissa (significand) bits.

Among second DFP data formats, the DFP_L data format may correspond to DFP_L(1-5-10); a data format that includes one sign bit, five exponent bits, and ten mantissa (significand) bits.

Turning to the operations of FIG. 4, in operation 410, the electronic device may determine a first threshold value and a second threshold value for dividing weights included in the target layer into ranges, based on a target MWE corresponding to the target layer. Here, the second threshold value may be less than the first threshold value. In other words, the electronic device may determine the first threshold value and the second threshold value, using a DFC algorithm.

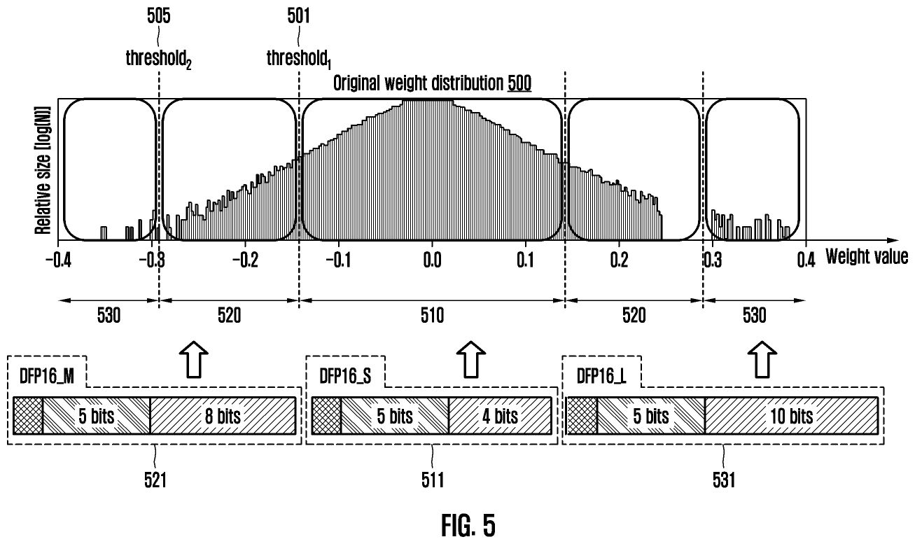

FIG. 5 illustrates an example of a DFC algorithm, according to one or more embodiments. FIG. 5 illustrates a weight distribution 500 of weights included in a target layer. A method of quantizing the weights included in the target layer from a first data format to a second data format is described next with reference to FIGS. 4 and 5.

In operation 420, the electronic device may quantize, into a first sub-format (e.g., the DFP_S data format), weights included in a range between a first threshold value (threshold₁) and a number having the negative of the first threshold value (−threshold₁) (hereinafter, first threshold opposite value). In sum, the electronic device may quantize weights included in a first range into the first sub-format.

Referring to FIG. 5, the weights included in the target layer may have the original weight distribution 500 (the distribution shown in FIG. 5 is an example). As shown in FIG. 5, an example of the above-mentioned first threshold value is shown as first threshold value 501 (threshold₁). The first threshold value 501 may define the boundaries of a first range 510 (e.g., (threshold₁, −threshold₁). For example, the weight distribution 500 may be a Gaussian distribution. The electronic device may quantize the weights of the weight distribution 500 that fall within the first range 510 into a first sub-format having the lowest precision (among the formats sub-formats being used for quantization). For example, the first sub-format may correspond to a DFP16_S data format 511 with a 4-bit precision.

In operation 430, the electronic device may quantize, into a first DFP data format (e.g., the DFP16_M data format 521 having 8-bit precision) among second sub-formats, weights included in a second range having a first sub-range 520A and a second sub-range 520B, which are defined by the first threshold (threshold₁) and a second threshold 505 (threshold₂). The first sub-range 520A may be (threshold₂, threshold₁), and the second sub-range 520B may be (−threshold₁, −threshold₂).

In operation 440, the electronic device may quantize, into the second DFP data format (e.g., the DFP16_L data format 531 having 10-bit precision), weights included in a third range having a third sub-range 530A and a fourth sub-range 530B, where the range 530A is all values less than the second threshold value 505 (−∞, threshold₂) and the fourth sub-range is all values greater than the opposite value of the second threshold value 505 (−threshold₂, ∞). Put another way, referring to FIG. 5, the electronic device may quantize the weights included in the third sub-range 530A and the fourth sub-range 530B into the second DFP data format (e.g., a DFP16_L data format 531).

The electronic device may determine the first threshold value (e.g., the first threshold value 501 of FIG. 5) (i.e., Th₁) and the second threshold value (e.g., the second threshold value 505 of FIG. 5) (i.e., Th₂), based on a DFC algorithm (see Equation 2 below). In addition, the electronic device may divide the weight distribution 500 of the weights included in the target layer into three different ranges, e.g., the first range 510, the second range (first sub-range 520A and second sub-range 520B), and the third range (third sub-range 530A and fourth sub-range 530B), and may do so based on the first threshold value and the second threshold value. Weights may be quantized into different data formats according to which of the three ranges they fall within; each range may have its own different data format.

For example, the electronic device may determine the first threshold value (Th₁) and the second threshold value (Th₂), based on Equation 2 below.

$$\begin{matrix}{Th}_{1} , {Th}_{2} = arg min {\sum }_{1}^{N} Computing Complexity ( f ( {w}_{i} ; {Th}_{1} , {Th}_{2} ) \times {x}_{i} ) , \\ s . t . Mean ( Abs ( f ( {w}_{i} ; {Th}_{1} , {Th}_{2} ) - w ) \leq MWE\end{matrix} \qquad Equation 2$$

In Equation 2, f denotes a function that converts a weight from the first data format into the second data format. w denotes a weight value, N denotes a number of weights (e.g., the number of weights in the weight distribution 500), and computing complexity( ) is a function representing a complexity of an arithmetic operation. x denotes input data that is input to the target layer. For example, computing complexity( ) may include piecewise functions, which are defined as different functions depending on a specific condition or a division of a domain. For example, when wᵢ has the DFP_L data format (e.g., the DFP16_L data format 531 of FIG. 5), a complexity of wᵢ×xᵢ may be 3. For example, when wᵢ is the DFP_M data format (e.g., the DFP16_M data format 521 of FIG. 5), a complexity of wᵢ×xᵢ may be 2. For example, when wᵢ is the DFP_S data format (e.g., DFP16_S data format 511 of FIG. 5), a complexity of wᵢ×xᵢ may be 1.

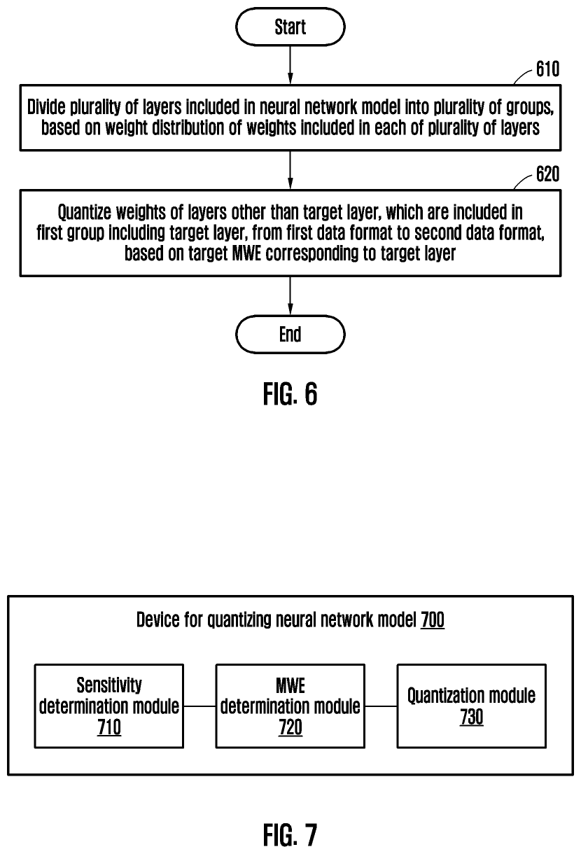

FIG. 6 illustrates an example of a neural network model quantization method performed by an electronic device, according to one or more embodiments.

In operation 610, the electronic device may divide layers included in a neural network model into groups of layers. For example, the electronic device may divide the layers into groups based on similarities of their weight distributions. Weights included in a first layer (among the layers) may have a first weight distribution. Weights included in a second layer (among the layers) may have a second weight distribution. The electronic device may calculate a similarity between the first weight distribution and the second weight distribution. Layers with a high similarity may be included in a same group according to their calculated similarities. In other words, the electronic device may put layers having a similar weight distribution into a same group. For example, layers having a weight distribution similar to the weight distribution of a target layer may be included in a first group. The dividing the layers into groups may be based on a clustering method (e.g., K-means) or other similarity calculation between the weight distributions. In another example, the electronic device may divide the of layers into groups based on the Union Find algorithm. However, the method by which the electronic device divides the plurality of layers into the plurality of groups is not limited thereto.

In operation 620, the electronic device may quantize weights of layers which are included in the first group (which may include the target layer) from a first data format to a second data format, based on a target MWE corresponding to the target layer. In other words, the electronic device may not need to perform a calculation to determine the MWE for the layers other than the target layer and may use the target MWE corresponding to the target layer as an MWE to be used for quantizing the other layers in the first group. Accordingly, the electronic device may reduce computational overhead for determining the MWE for the layers included in the first group and thus improve processing performance of an AI chip.

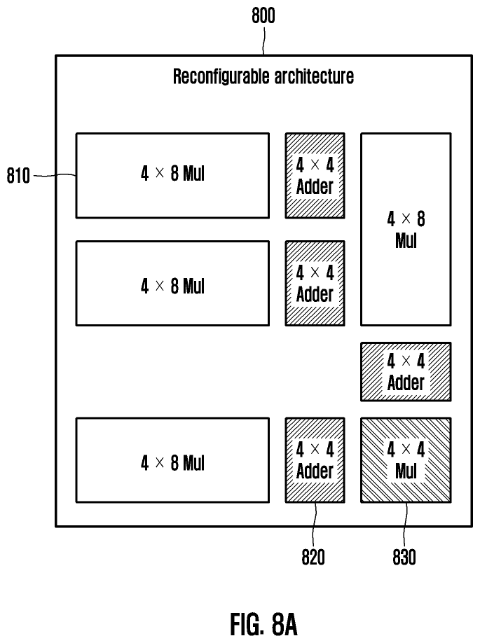

FIG. 7 illustrates an example of a device that quantizes a neural network model, according to one or more embodiments.

A device 700 for quantizing a neural network model may include a sensitivity determination module 710, an MWE determination module 720, and a quantization module 730. The sensitivity determination module 710 may determine sensitivities corresponding to MWEs, respectively, for quantizing one or more layers among layers of the neural network model. In other words, the sensitivity determination module 710 may determine the sensitivities corresponding to the target layer among the layers included in the neural network model. For reference, candidate MWEs may be determined in advance for the target layer. The sensitivity determination module 710 may determine the sensitivities of the target layer so that an error between the weights of the target layer before quantization of the neural network model and the weights after the quantization of the neural network model may be less than or equal to a candidate MWE. The MWE determination module 720 may determine a target MWE corresponding to the target layer among the candidate MWEs, based on the sensitivities of the respective candidate MWEs. The quantization module 730 may quantize weights included in the target layer from a first data format to a second data format, based on the target MWE corresponding to the target layer. In other words, the sensitivity determination module 710 may determine a sensitivity corresponding to the target layer. The MWE determination module 720 may determine/select the target MWE corresponding to the target layer. The quantization module 730 may quantize the neural network model including the target layer. Operations of the sensitivity determination module 710, the MWE determination module 720, and the quantization module 730 are generally as described with reference to FIGS. 1 to 6.

The device 700 for quantizing a neural network model may further include a group division module (not shown). The group division module may divide layers included in the neural network model into groups, based on weight distributions of the respective layers. Among the groups, weight distributions may in a given group may be similar. In this case, the target layer may belong to a first group. The quantization module 730 may quantize weights included in non-target-layer layers of the first group from the first data format to the second data format, based on the target MWE of the target layer.

Hereinafter and in the description with reference to FIG. 7, an operation of the electronic device is described based on the terms such as a sensitivity determination module 710, the MWE determination module 720, a quantization module 730, and a group division module (not shown), but the description is not limited thereto. Operations of the sensitivity determination module 710, the MWE determination module 720, the quantization module 730, and the group division module described with reference to FIG. 7 may be performed by a processor (or combination of processors).

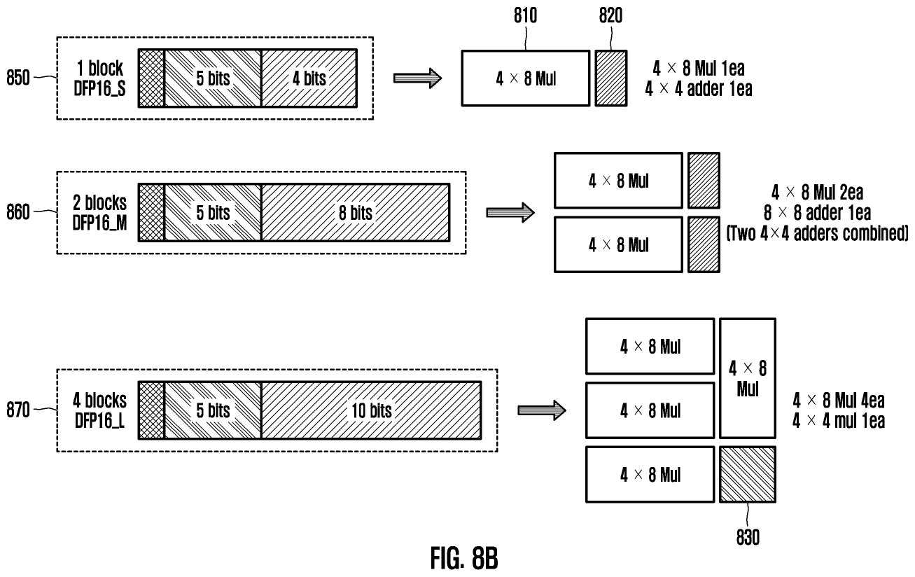

FIGS. 8A and 8B illustrate an example of an architecture of an electronic device that operates a neural network model, according to one or more embodiments.

An electronic device 800 of FIG. 8A may have a hardware architecture for processing data having different data formats. For example, the electronic device 800 may include a 4×8 multiplier 810, a 4×4 adder 820, and a 4×4 multiplier 830. Arrangements of the 4×8 multiplier 810, the 4×4 adder 820, and the 4×4 multiplier 830 in the electronic device 800 illustrated in FIG. 8A is only an example, and the arrangements of the 4×8 multiplier 810, the 4×4 adder 820, and the 4×4 multiplier 830 in the electronic device 800 are not limited thereto.

FIG. 8B illustrates an example of a configuration in which the electronic device 800 stores and operates each piece of data of different data formats.

For example, the electronic device 800 may store data of the DFP16_S format (e.g., a format including one sign bit, five exponent bits, and four mantissa bits) in one block 850. For reference, block 850 represents data composed of multiple bits. The electronic device 800 may use one 4×8 multiplier 810 and one 4×4 adder 820 for multiplication and accumulation operations between data of the DFP16_S format.

For example, the electronic device 800 may store data of the DFP16_M format (e.g., a format including one sign bit, five exponent bits, and eight mantissa bits) in two blocks 860. The electronic device 800 may use two 4×8 multipliers 810 and two 4×4 adders 820 for multiplication and accumulation operations between data of the DFP16_M format.

For example, the electronic device 800 may store data of the DFP16_L format (e.g., a format including one sign bit, five exponent bits, and ten mantissa bits) in four blocks 870. The electronic device 800 may use four 4×8 multipliers 810 and one 4×4 multiplier 830 for multiplication and accumulation operations between data of the DFP16_L format.

In other words, the electronic device 800 may be provided with at least four 4×8 multipliers 810, two 4×4 adders 820, and one 4×4 multiplier 830 to perform multiplication and accumulation operations on each of the data of the DFP16_S, DFP16_M, and DFP16_L formats. However, hardware design requirements of the electronic device 800 may be reduced through a DFC algorithm.

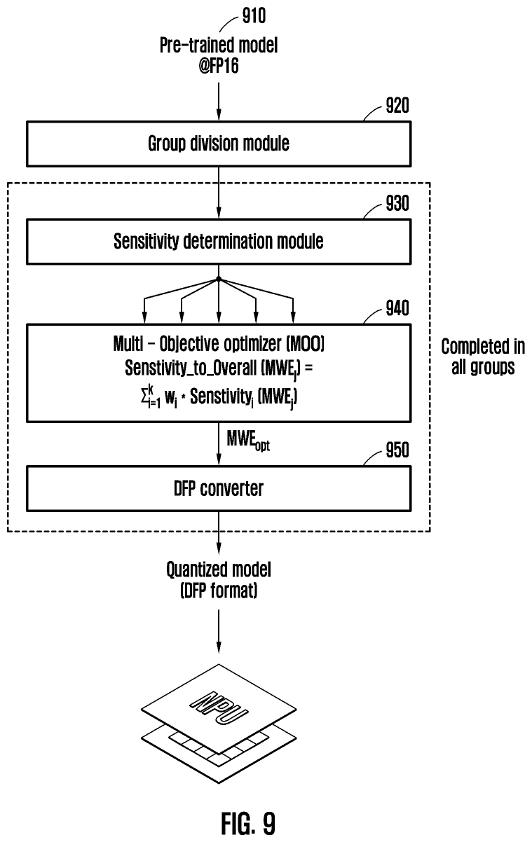

FIG. 9 illustrates an example of an overall flow of a neural network model quantization algorithm, according to one or more embodiments.

An electronic device may obtain a pre-trained model 910. The pre-trained model 910 may be any of the neural network models described with reference to FIGS. 1 to 8B. For example, the pre-trained model 910 obtained by the electronic device may include a neural network model that is configured to be implemented with operations based on data of the FP16 data format (e.g., weights may be in the FP16 format).

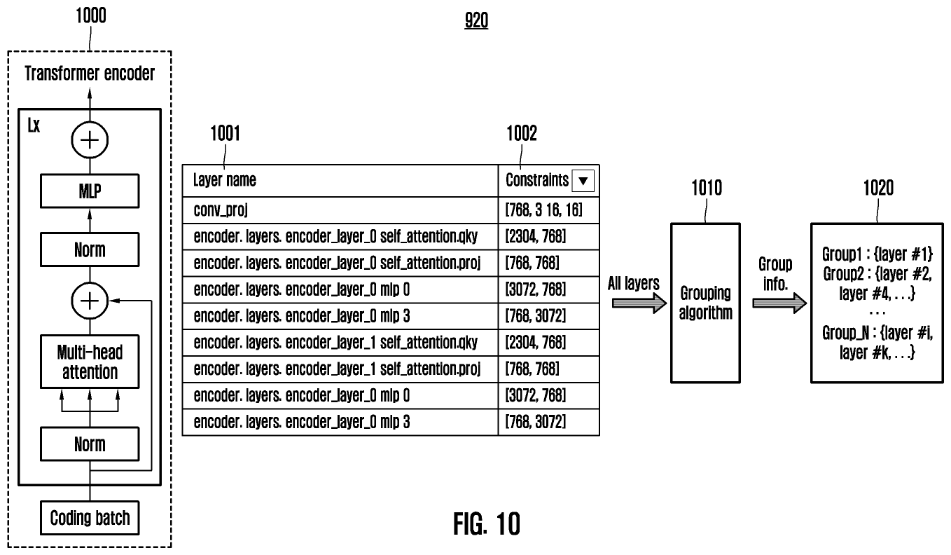

A group division module 920 may group layers included in the pre-trained model 910. The operation of the group division module 920 is described in more detail with reference to FIG. 10.

The group division module 920 may provide a grouping result for the layers included in the pre-trained model 910 to a sensitivity determination module 930. The sensitivity determination module 930 may determine a sensitivity corresponding to each group. For example, a configuration space (e.g., {MWE_1, MWE_2, . . . , MWE_k}) including k MWE parameters corresponding to a predetermined MWE may be provided. The sensitivity determination module 930 may select one parameter MWE_i each time from the configuration space including the MWE parameters. The sensitivity determination module 930 may select one of the layers included in the group as a current layer, based on the grouping result of the group division module 920. For example, the electronic device may convert (or quantize) the current layer into a DFP format depending on the selected MWE. The electronic device may input a same sample to two neural network models to obtain two respective different sets of outputs; the two models may be a pre-quantization model and a post-quantization model. The sensitivity determination module 930 may calculate a sensitivity corresponding to the selected MWE of the current layer for a performance indicator (e.g., a CCR and a computational accuracy of a layer), based on the two sets of outputs, using a Kullback-Leibler divergence (KLD) method. For example, the performance indicator may be one or more of different performance indicators (e.g., power consumption of a chip, and an area of the chip, a CCR, and a computational accuracy of a layer).

A multi-objective optimizer (hereinafter, MOO) 940 may calculate a target sensitivity for a target layer, based on the sensitivity calculated by the sensitivity determination module 930 for the different performance indicators. The MOO 940 may determine a target MWE value (e.g., MWE_{OPT}) corresponding to a layer included in the neural network model, based on the target sensitivity. Operation of the MOO 940 is described in more detail with reference to FIG. 11.

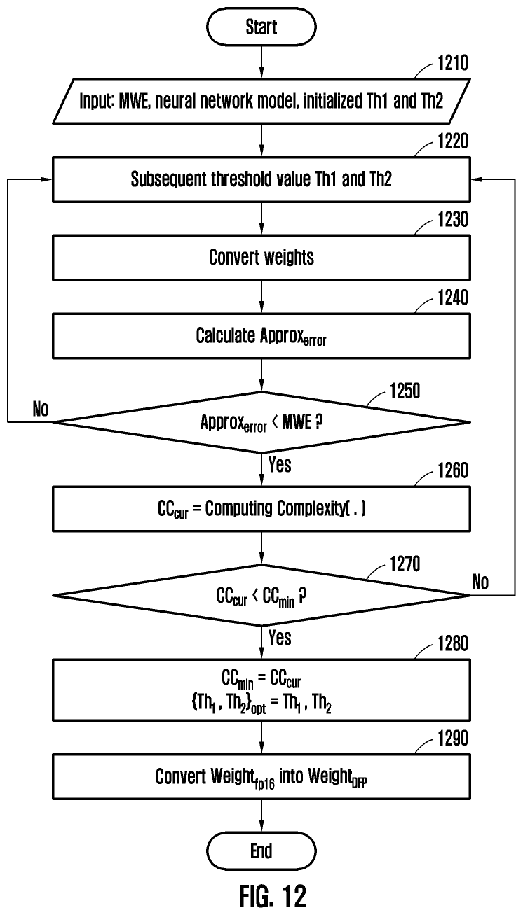

A DFP converter 950 (e.g., the quantization module 730 of FIG. 7) may quantize weights included in the target layer from a first data format to a second data format according to the MWE value determined by the MOO 940. Operation of the DFP converter 950 is described in more detail with reference to FIG. 12.

FIG. 10 illustrates an example of an overall flow in which the group division module 920 divides a neural network model 1000 (e.g., a transformer encoder) into groups, based on a cross-layer grouping algorithm, according to one or more embodiments.

The group division module 920 may perform a cross-layer grouping algorithm 1010 (FIG. 10). The group division module 920 may analyze layers included in the neural network model 1000. For example, the layers included in the neural network model 1000 may include weights. Each layer of the neural network model 1000 may have a weight distribution. The group division module 920 may calculate the weight distributions of the respective layers included in the neural network model 1000. For example, the group division module 920 may analyze the layers of the neural network model 1000, based on a clustering method or a similarity calculation as applied to the weight distributions of the layers. For example, the group division module 920 may analyze a layer name (or identifier) 1001 of each layer included in the neural network model 1000 and constraints 1002 corresponding to the layer name 1001 in a table format. For example, the group division module 920 may divide layers having relatively similar weight distributions into a same group, based on an analysis result. For example, the group division module 920 may calculate a similarity between a first weight distribution of weights included in a first layer and a second weight distribution of weights included in a second layer, among the layers included in the neural network model 1000. The group division module 920 may determine whether to put the first layer and the second layer into the same group or different groups, based on the similarity of their calculated weight distributions. In other words, the group division module 920 may group the first layer and the second layer into the same group when the weight distribution of the first layer and the weight distribution of the second layer have a similarity below a threshold. In another example, the group division module 920 may divide the first layer and the second layer into different groups when the weight distribution of the first layer and the weight distribution of the second layer are not similar. In addition, the group division module 920 may perform group division using the Union Find algorithm. The group division module 920 may divide all layers included in the neural network model 1000 into different groups, based on the similarities of pairs of weight distributions (e.g., for all possible pairings). For example, groups 1020 divided based on the group division module 920 may include Group 1, Group 2, and Group N. Here, N may represent a natural number greater than or equal to 1. For example, Group 1 may include the first layer (e.g., layer #1 of FIG. 10) included in the neural network model 1000. For example, Group 2 may include the second layer (e.g., layer #2 of FIG. 10) and a fourth layer (e.g., layer #4 of FIG. 10) included in the neural network model 1000. For example, Group N may include an i-th layer (e.g., layer #i of FIG. 10) and a k-th layer (e.g., layer #k of FIG. 10) included in the neural network model 1000, where i and k are natural numbers greater than or equal to 2. Weight distributions of layers included in one group may be similar to each other. By grouping the layers of the neural network model 1000 based on the similarities between the weight distributions, the group division module 920 may reduce computational overhead that may occur when performing a sensitivity analysis on each layer. For example, sensitivity analysis may be performed on one representative layer of a group (e.g., a target layer), and that sensitivity analysis may apply to all layers in the group.

FIG. 11 illustrates an example of an overall flow of a multi-objective optimization algorithm, according to one or more embodiments.

The MOO 940 may normalize 1120 and 1121 sensitivity values 1110 and 1111 corresponding to different performance indicators (e.g., the computational accuracy (Acc), the CCR (CCR), and the power consumption of a chip (power)). The MOO 940 may obtain a target sensitivity corresponding to a target layer by multiplying the normalized sensitivities of the different performance indicators by weights (e.g., w₁, w₂, . . . , wₙ of FIG. 11, wherein n is a natural number greater than or equal to 2) and summing the multiplication results (these weights are not weights of the neural network model being quantized). The MOO 940 may sort the obtained target sensitivities and determine/select whichever MWE value is associated with the smallest target sensitivity to be a target MWE value (e.g., MWE_{OPT}).

In FIG. 11, S_{ACC} (MWEᵢ) denotes a sensitivity to a first performance indicator (e.g., the computational accuracy (Acc) of the target layer) corresponding to an MWE MWEᵢ. S_{CCR}(MWEᵢ) denotes a sensitivity to a second performance indicator (e.g., the CCR) corresponding to the MWE MWEᵢ. S_{POWER}(MWEᵢ) denotes a sensitivity to an n-th performance indicator (e.g., the power consumption of a chip) corresponding to the MWE MWEᵢ. As shown in FIG. 11, w₁ denotes a weight for the first performance indicator. w₂ denotes a weight for the second performance indicator. wₙ denotes a weight of the sensitivity to the n-th performance indicator. The weights may be set in various ways, for example, by a user input or based on information indicating the relative importance of the different performance indicators.

The MOO 940 may obtain the target sensitivity by considering sensitivities corresponding to the different performance indicators, using a weighted sum method. Weight coefficients (e.g., w₁, w₂, . . . , wₙ) for a weighted sum of the different performance indicators (e.g., the first performance indicator, the second performance indicator, or the n-th performance indicator) may be predetermined. For example, a user may predetermine values of the weight coefficients (e.g., w₁, w₂, . . . , wₙ). For example, a user may predetermine a greater weight for a preferred performance indicator among the different performance indicators.

The MOO 940 may sort target sensitivities (e.g., Sₒ (MWEₘᵢₙ), Sₒ (MWEᵢ), . . . , Sₒ (MWEₘₐₓ)) corresponding to different MWEs (e.g., MWEₘᵢₙ, MWEᵢ, . . . , MWEₘₐₓ) and determine an MWE corresponding to the least target sensitivity to be the target MWE (e.g., MWE_{OPT}). An electronic device may achieve optimization of the performance indicators, based on the determined MWE.

FIG. 12 illustrates an example of an overall flow of a DFC algorithm, according to one or more embodiments.

In operation 1210, an electronic device may receive a neural network model and an input value for the neural network model and may initialize a process. Here, the input value may include a weight parameter of FP16 format, an MWE parameter (e.g., a candidate MWE), and thresholds (e.g., Th1 and Th2) initialized to 0.

In operation 1220, the electronic device may change values of the thresholds Th1 and Th2. The values of the thresholds Th1 and Th2 may be set or changed based on a predetermined method. For example, the electronic device may set candidate thresholds. For example, the electronic device may change an existing threshold to a new threshold within a range of the candidate thresholds.

In operation 1230, the electronic device may convert weights included in the neural network model. For example, the electronic device may reduce a precision of the received weight parameter. In other words, the electronic device may convert a weight parameter of FP16 format into a weight parameter of a DFP mixed precision format, based on the changed values of the thresholds Th1 and Th2.

In operation 1240, the electronic device may calculate a conversion error (e.g., Approx error) which is a difference an output of the model before reducing precision and an output of the model after reducing the precision.

In operation 1250, the electronic device may determine whether the conversion error (e.g., Approxₑᵣᵣₒᵣ) satisfies MWE constraints. For example, the electronic device may determine whether the conversion error (e.g., Approx error) is less than a predetermined candidate MWE. When the conversion error is greater than or equal to the predetermined candidate MWE, the electronic device may return to operation 1220 to update the thresholds Th1 and Th2. Alternatively, the electronic device may proceed to operation 1260 when the conversion error is less than the predetermined candidate MWE. In operation 1260, the electronic device may calculate an arithmetic operation complexity(e.g., computing complexity; CC_{cur}) in a layer included in the neural network model.

In operation 1270, the electronic device may determine whether the computing complexity(e.g., CC_{cur}) is less than a global minimum complexity(e.g., CCₘᵢₙ). For example, the electronic device may proceed to operation 1280 when the computing complexity is less than the global minimum complexity. In operation 1280, the electronic device may update the global minimum complexity(e.g., CCₘᵢₙ) to the computing complexity(e.g., CC_{cur}) and store thresholds at that time as optimal thresholds (e.g., {Th1, Th2} opt). In another example, when the computing complexity is greater than or equal to the global minimum complexity in operation 1270, the electronic device may return to operation 1220 and update the thresholds Th1 and Th2. Thus, the electronic device may obtain a global optimal complexity and an optimal threshold after exploring all possible Th1 and Th2.

In operation 1290, the electronic device may perform format conversion (quantization) of a weight parameter included in the neural network model. For example, the electronic device may convert a weight parameter of the FP16 format to a weight parameter of the DFP format, based on the updated optimal thresholds (e.g., {Th1, Th2} opt).

The electronic device may quickly find a threshold that satisfies an MWE, based on the DFC algorithm shown in FIG. 12. Accordingly, the electronic device may reduce computational overhead.

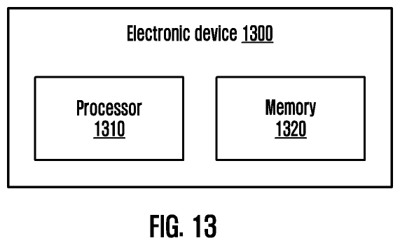

FIG. 13 illustrates an example of an electronic device, according to one or more embodiments.

An electronic device 1300 may include a processor 1310 and a memory 1320. The memory 1320 may store a computer program. The memory 1320 may store instructions for operating the processor 1310. The electronic device 1300 may execute one of the methods described with reference to FIGS. 1 to 12 by executing, based on the processor 1310, the computer program stored in the memory 1320. The one method described with reference to FIGS. 1 to 12, executed by the processor 1310, is not described again herein. In addition, as described with reference to FIG. 7, the processor 1310 may perform operations of a sensitivity determination module (the sensitivity determination module 710 of FIG. 7), an MWE determination module (the MWE determination module 720 of FIG. 7), a quantization module (the quantization module 730 of FIG. 7), and a group division module. In practice, the processor 1310 may be a combination of one or more processors of any type(s), including types of processors described herein, but not limited thereto.

The examples described herein may be implemented using hardware components, software components (in the form of instructions), and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include processors, or a single processor and a single controller. In addition, a different processing configuration is possible, such as one including parallel processors.

The software/instructions may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A quantization method for quantizing a target layer among layers of a neural network model, the method performed by one or more processors and comprising:
determining sensitivities corresponding to one candidate max weight error (MWE) among candidate MWEs corresponding to the target layer, the sensitivities indicating sensitivity of the neural network model to quantization;
determining a target MWE corresponding to the target layer, based on the sensitivities; and
based on the determined target MWE, quantizing weights included in the target layer from a first data format to a second data format.

2. The quantization method of claim 1, wherein the determining of the sensitivities comprises:
determining a first sensitivity of the target layer to a first performance indicator, the first sensitivity corresponding to the determined target MWE;
determining a second sensitivity of the target layer to a second performance indicator, the second sensitivity corresponding to the determined target MWE; and
determining a target sensitivity of the target layer, the target sensitivity corresponding to the determined target MWE, based on combining the first sensitivity and the second sensitivity.

3. The quantization method of claim 2, wherein,
in response to operating, based on a artificial intelligence (AI) chip, a quantized model obtained by quantizing weights included in the target layer from the first data format to the second data format, the first performance indicator and the second performance indicator each corresponding to one of power consumption of the AI chip, an area of the AI chip, a computational complexity ratio (CCR), or a computational accuracy of the quantization model, and wherein
the first performance indicator is different from the second performance indicator.

4. The quantization method of claim 1, wherein the determining of the sensitivities comprises:
generating first output data, based on inputting first input data to the neural network model;
generating a quantized model by quantizing, based on the determined target MWE, the weights included in the target layer from the first data format to the second data format;
generating second output data, based on inputting the first input data to the quantized model; and
determining a target sensitivity of the target layer based on the first output data and the second output data, the target sensitivity corresponding to the determined target MWE.

5. The quantization method of claim 1, wherein the determining of the target MWE is based on a comparison result of sensitivities corresponding to the one candidate MWE and sensitivities, other than the one candidate MWE, corresponding to other candidate MWEs.

6. The quantization method of claim 1, wherein
the second data format comprises a first sub-format and a second sub-format,
a precision of the first sub-format or the second sub-format is lower than a precision of the first data format, and
the quantizing of the weights included in the target layer from the first data format to the second data format, based on the target MWE, comprises:
quantizing weights of the target layer determined to fall within a first range into the first sub-format; and
quantizing weights of the target layer determined to fall within a second range into the second sub-format.

7. The quantization method of claim 6, wherein
the first data format corresponds to a half-precision data format,
the second data format comprises a first dynamic floating-point data format and a second dynamic floating-point data format, which have a predetermined precision size, and
the quantizing of the weights included in the target layer from the first data format to the second data format, based on the target MWE, comprises:
determining a first threshold value and a second threshold value less than the first threshold value, wherein a first and second ranges are defined according to the first and second thresholds;
quantizing, into the first sub-format, weights of the target layer that fall within the first range; and
quantizing, into the first DFP data format, weights of the target layer that fall within the second range.

8. The quantization method of claim 1, further comprising:
performing inference based on inputting multimedia data to a quantized model generated through the quantization of the neural network model,
wherein the multimedia data comprises:
at least one of text data, image data, or voice data.

9. The quantization method of claim 1, further comprising:
dividing the layers into groups, based on weight distributions of the respective layers; and
quantizing weights of layers other than the target layer, which are included in a first group, among the groups, comprising the target layer, from the first data format to the second data format, based on the target MWE corresponding to the target layer.

10. The quantization method of claim 9, wherein the dividing of the layers into the groups comprises:
calculating a similarity between a first weight distribution of a first layer and a second weight distribution of a second layer, among the layers; and
dividing the layers into the groups based on the calculated similarity.

11. A non-transitory computer-readable storage medium storing instructions that, when executed by a processor, cause the processor to perform the method of claim 1.

12. A quantization device for a neural network model, the quantization device comprising:
one or more processors; and
a memory storing instructions configured to cause the one or more processors to:
determine sensitivities corresponding to one candidate max weight error (MWE) among predetermined candidate MWEs corresponding to a target layer among layers of the neural network model;
determine a target MWE corresponding to the target layer, based on the sensitivities; and
quantize weights included in the target layer from a first data format to a second data format, based on the target MWE.

13. The quantization device of claim 12, wherein the determining the sensitivities includes:
determining a first sensitivity of the target layer to a first performance indicator, the first sensitivity corresponding to the determined target MWE;
determining a second sensitivity of the target layer to a second performance indicator, the second sensitivity corresponding to the determined target MWE; and
determining a target sensitivity of the target layer, the target sensitivity corresponding to the determined target MWE, based on combining the first sensitivity and the second sensitivity.

14. The quantization device of claim 13, wherein,
in response to operating, based on an artificial intelligence (AI) chip, a quantized model obtained by quantizing weights included in the target layer from the first data format to the second data format, the first performance indicator and the second performance indicator each correspond to one of power consumption of the AI chip, an area of the AI chip, a computational complexity ratio (CCR), or a computational accuracy of the quantization model, and
the first performance indicator is different from the second performance indicator.

15. The quantization device of claim 12, wherein the determining the sensitivities includes:
generating first output data, based on inputting first input data to the neural network model;
generate a quantized model by quantizing the weights included in the target layer from the first data format to the second data format, based on the determined target MWE;
generate second output data, based on inputting the first input data to the quantized model; and
determine a target sensitivity of the target layer, the target sensitivity corresponding to the determined target MWE, based on the first output data and the second output data.

16. The quantization device of claim 12, wherein the determining the target MWE is based on a comparison result of sensitivities corresponding to the one candidate MWE and sensitivities corresponding to candidate MWEs other than the one candidate MWE.

17. The quantization device of claim 12, wherein
the second data format comprises a first sub-format and a second sub-format,
a precision of at least one of the first sub-format or the second sub-format is lower than a precision of the first data format, and
the quantizing includes:
quantizing weights determined to be within a first range into the first sub-format; and
quantizing weights determined to be within a second range into the second sub-format.

18. The quantization device of claim 17, wherein
the first data format comprises a half-precision data format,
the second data format comprises a first dynamic floating-point data format and a second dynamic floating-point data format, which have a predetermined precision size, and
the quantizing includes:
determining a first threshold value and a second threshold value less than the first threshold value for dividing the weights included in the target layer into ranges, based on the target MWE, wherein the first range and the second range are determined according to the first and second threshold values.

19. The quantization device of claim 12, wherein the instructions are further configured to cause the one or more processors to:
divide the layers into groups based on weight distributions of the respective layers, the groups including a first group, each weight distribution being a distribution of weights in a corresponding layer among the layers; and
quantize weights of layers other than the target layer in the first group, from the first data format to the second data format, based on the target MWE corresponding to the target layer.

20. The quantization device of claim 19, wherein the instructions are further configured to cause the one or more processors to:
calculate a similarity between a first weight distribution of weights included in a first layer among the layers and a second weight distribution of weights included in a second layer among the layers; and
divide the layers into the groups, based on the calculated similarity.
